(19) United States
(12) Patent Application Publication
(10) Pub. No.: US 2020/0235403 A1
(43) Pub. Date: Jul. 23, 2020

(54) Graphene Coated Anode Particles for a Lithium Ion Secondary Battery

(71) Applicants: Chongqing Jinkang New Energy Automobile Co., Ltd., Chongqing (CN); SF Motors Inc., Santa Clara, CA (US)

(72) Inventor: Masatsugu Nakano, Kakogawa City (JP)

(21) Appl. No.: 16/251,041

(22) Filed: Jan. 17, 2019

(51) Int. Cl. H01M 4/62; H01M 4/134; H01M 4/131; H01M 4/1395; H01M 4/1391; H01M 4/525; H01M 4/38; H01M 10/0585; H01M 10/0562; H01M 10/0525

(52) U.S. Cl. CPC H01M 4/625; H01M 4/134; H01M 4/131; H01M 4/1395; H01M 4/1391; H01M 2004/021; H01M 4/386; H01M 10/0585; H01M 10/0562; H01M 10/0525; H01M 4/525

(57) ABSTRACT

Various solid state battery arrangements are presented herein. Solid state batteries are detailed that have a cathode may be from cathode active material particles coated in graphene. Additionally or alternatively, an anode may be made from anode active material particles coated in graphene. Use of graphene-coated particles may allow for a solid electrolyte layer thickness to be decreased or for the solid electrolyte layer to be eliminated in its entirety.

### CROSS-REFERENCES TO RELATED APPLICATIONS

This application is related to U.S. patent application Ser. No. ______, entitled “Graphene Coated Cathode Particles for a Lithium Ion Secondary Battery”, filed on the same day as this application, having an attorney document number of 1116002, the entire disclosure of which is hereby incorporated by reference for all purposes.

### BACKGROUND

In a solid-state battery (SSB), a solid electrolyte may be present between an anode and a cathode. The solid electrolyte may exhibit high ion conductivity (e.g., lithium ion conductivity in the example of a lithium ion battery), low electro-conductivity, and a low amount of flexibility. The use of such a solid electrolyte between an anode and cathode of a SSB may not be ideal. The greater the amount of such a solid electrolyte used relative to the amount of active cathode material, the lower the energy density of the battery. If a small thickness of such a solid electrolyte is used between the anode and the cathode, the possibility of a short circuit developing between the anode and cathode may be possible. However, if a large thickness is used, the overall performance, such as the power density, of the battery may be low. Therefore, achieving a high energy density in a SSB may be difficult using conventional arrangements.

### SUMMARY

As detailed herein, the use of a new solid electrolyte material arrangement has moderate electron conductivity, ionic conductivity and flexibility. The use of such a material can make it possible to thin the electrode and realize high energy density. Solid electrolyte can be applied to anode material, such as silicon or silicon mono-oxide.

Various embodiments are described related to a solid state battery. In some embodiments, a solid state battery is described. The device may include an anode layer. The device may include a cathode layer comprising active material cathode particles. Individual active material cathode particles may be coated in graphene.

Embodiments of such a device may include one or more of the following features: no solid electrolyte layer may be present between the anode layer and the cathode layer of the solid state battery. The anode layer may directly contact the cathode layer. A solid electrolyte layer may be present between the anode layer and the cathode layer including the active material cathode particles coated in graphene. The solid electrolyte layer may be between 10 μm and 30 μm in thickness. The cathode may further include solid electrolyte particles being mixed with the active material cathode particles coated in graphene. The active material cathode particles coated in graphene may be less than 26 micrometers in diameter. The cathode may further include carbon fiber strands. An active material of the active material cathode particles may be lithium nickel cobalt aluminum oxide.

In some embodiments, a method for creating a solid state battery is described. The method may include performing a process to coat active material cathode particles with graphene. The method may include creating a cathode using the active material cathode particles coated with graphene. The method may include creating the solid state battery using the created cathode and an anode.

Embodiments of such a method may include one or more of the following features: no solid electrolyte layer may be present between the anode layer and the cathode layer. The solid state battery may be created such that the anode layer directly touches the created cathode layer. The method may further include creating a solid electrolyte. Creating the solid state battery using the created cathode and the anode layer may further include using the solid electrolyte. The solid electrolyte may be positioned between the anode layer and the created cathode layer. Creating the cathode layer using the active material cathode particles coated in graphene may further include adding solid electrolyte particles to the cathode layer. Adding solid electrolyte particles to the cathode may include soaking the cathode layer comprising the active material cathode particles coated in graphene with a solid electrolyte suspended in a liquid. The method may include drying the cathode layer to remove the liquid from the cathode layer. Creating the cathode layer using the active material cathode particles coated in graphene may further include adding carbon fiber strands to the cathode layer. Performing the process to coat the active material cathode particles with the graphene may include performing a mechanical nano-fusion process to coat the active material cathode particles with graphene. Performing the process to coat the active material cathode particles with graphene may include performing a spray coating process to coat the active material cathode particles with graphene. The active material cathode particles coated in graphene may be less than 26 micrometers in diameter. The active material of the active material cathode particles may be lithium nickel cobalt aluminum oxide.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a block diagram of a solid state battery without having a solid electrolyte layer.

FIG. 1B illustrates a block diagram of a solid state battery having a solid electrolyte layer.

FIG. 2 illustrates a cathode made from active material particles coated in graphene.

FIG. 3 illustrates a cathode made from active material particles coated in graphene with solid electrolyte being interspersed with the active material particles coated in graphene.

FIG. 4 illustrates a cathode made from active material particles coated in graphene with solid electrolyte being interspersed with the active material particles coated in graphene.

FIG. 5 illustrates an embodiment of a method for creating a solid state battery having coated cathode particles.

FIG. 6 illustrates an embodiment of another method for creating a solid state battery.

FIG. 7 illustrates an embodiment of an anode made from active material particles coated in graphene.

FIG. 8 illustrates an embodiment of an anode having bare silicon, conductive fibers, and conductive material that is exposed to charge and discharge cycles.

FIG. 9 illustrates an embodiment of an anode having graphene coated silicon exposed to charge and discharge cycles.

FIG. 10 illustrates an embodiment of a method for creating a solid state battery having coated anode particles.

FIG. 11 illustrates an embodiment of a method for creating a solid state battery having coated cathode and anode particles.

### DETAILED DESCRIPTION

As detailed herein, it may be possible to eliminate the need for a portion or all of the solid-state electrolyte layer to be present between an anode and a cathode. By eliminating the need for the solid-state electrolyte layer, the energy density of a solid-state battery may be increased. That is, by decreasing the weight of electrolyte, the weight of active components, such as the anode and cathode, can be increased while maintaining the same total weight of the solid-state battery.

Improvements may be made to the battery's cathode, anode, or both. Cathode particles may be coated with a material that can eliminate the need for some or all of a solid electrolyte layer (and, possibly, separator layer) between an anode and a cathode. Cathode particles may be coated with graphene. Graphene can exhibit good Lithium ion conductivity, high electro-conductivity, and a high amount of flexibility. Cathode particles coated in graphene may be created that is on the order of 4 to 26 micrometers in diameter. Such coated cathode particles may be approximately spherical. In some embodiments, a space between the coated cathode particles may be filled with a solid electrolyte material. By adding a solid electrolyte material into the empty spaces between particles, the lithium ion conductivity of the solid state battery may be increased. In some embodiments, a thin (compared to if the cathode particles were uncoated) solid electrolyte layer may be present. Additionally or alternatively, carbon fibers (vapor grown carbon fibers) may be introduced among the coated cathode particles of the cathode to increase conductivity.

Anode particles, such as silicon or silicon oxide, may be coated with a material that exhibits good lithium ion conductivity, high electro-conductivity, and a high amount of flexibility. Anode particles may be coated with graphene. Anode particles may be between 0.1 μm and 10 μm in diameter if silicon is used, or, if silicon dioxide is used, the diameter may be between 1 μm to 20 μm. The average diameter of coated particles may be between 2 μm and 5 μm. Such coated anode particles may be approximately spherical. An anode formed using such graphene-coated anode active material particles may exhibit various properties compared to anodes that use uncoated anode active material particles. For example, charge and discharge cycles may tend to cause uncoated particles to swell and shrink. This swelling and shrinking may tend to displace other materials, such as vapor grown carbon fibers (VGCFs), conductive materials, or both. This displacement, over time, may degrade the performance of the anode. Graphene coated anode particles may tend to swell less than uncoated anode active material particles. Further, such graphene coated anode particles may not need additional conductive material interspersed within the anode. Due to the lack of additional particles and the reduction in swelling, the performance of the anode having the graphene-coated anode particles may be improved compared to anodes having uncoated particles.

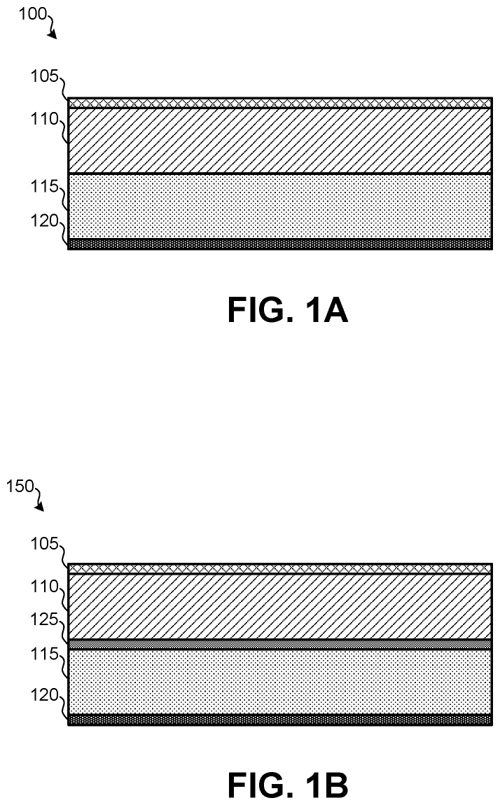

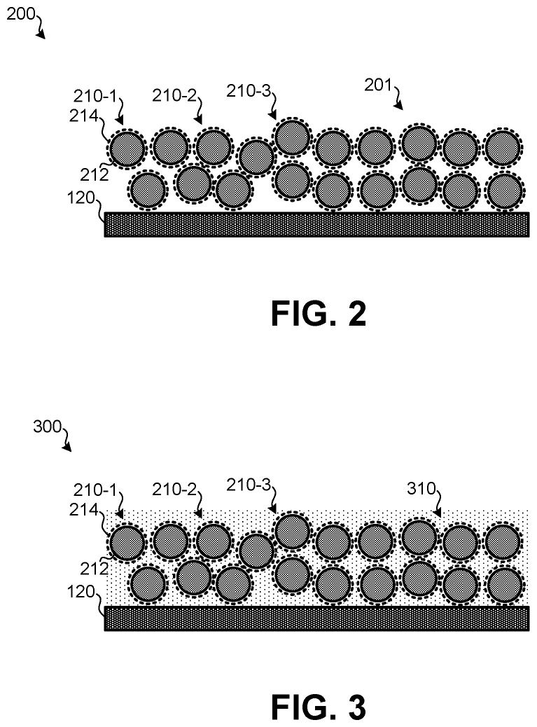

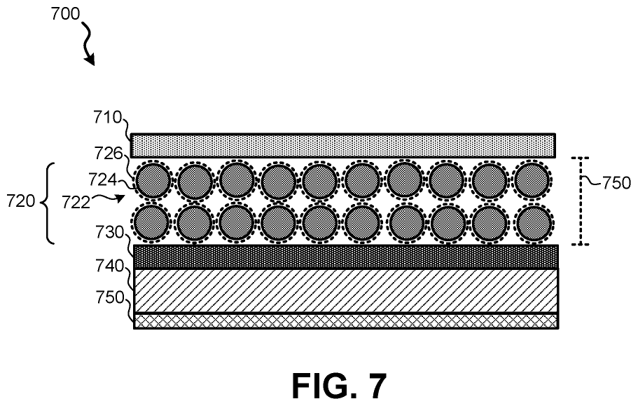

FIG. 1A illustrates a block diagram of an embodiment of a solid state battery 100 without having a solid electrolyte layer. Solid state battery 100 may include: cathode current collector 120; cathode 115; anode 110; and anode current collector 105. Cathode current collector may be a metallic layer, such as a layer of aluminum foil, that is in contact with cathode 115. Cathode 115 may be as detailed in relation to FIG. 2, 3, or 4. Cathode 115 may contact anode 110 or may be separated from anode 110 by a thin separator layer that is non-reactive by allows ions to pass through. For example, such a thin separator layer may be polyethylene (PE) or polypropylene (PP). Anode 110 may be created as detailed in relation to FIGS. 7-11. Anode 110 may be in contact with anode current collector 105. Anode current collector 105 may be a metallic foil, such as copper foil or nickel.

FIG. 1B illustrates a block diagram of an embodiment of a solid state battery 150 having a solid electrolyte layer. Solid state battery 150 may include cathode current collector 120; cathode 115; electrolyte layer 125; anode 110; and anode current collector 105. Cathode current collector may be a metallic layer, such as a layer of aluminum foil, that is in contact with cathode 115. Cathode 115 may be as detailed in relation to FIG. 2, 3, or 4. Cathode 115 may contact electrolyte layer 125. Electrolyte layer 125, on an opposite side, may contact anode 110. Electrolyte layer 125 may be formed from a lithium component that is added to a sulfide. For example, solid electrolyte layer 125 may be Li₂S—P₂S₅. For example, For solid electrolyte layer 125, sulfur-based materials such as thio-LISICONs (Lithium Super Ionic CONductors) that include LiGePS (LGPS), Li2S—P2S5 (LPS), Li_{9.54}Si_{1.74}P_{1.44}S_{11.7}Cl_{0.3}, and oxide such as LISICONs that include Li₁₄ZnGe₄O₁₆, Li₇La₃Zr₂O₁₂ (LLZO) can be used. Anode 110 may be created as detailed in relation to FIGS. 7-11. Anode 110 may be in contact with anode current collector 105. Anode current collector 105 may be a metallic foil, such as copper foil. Electrolyte layer 125 may be thinner due to the construction of cathode 115 than if a conventional cathode material is used. For example, a thickness of 20 μm may be used for the electrolyte layer. In other embodiments, a thickness of between 10 μm and 30 μm may be used.

FIG. 2 illustrates an embodiment 200 of a cathode made from active material particles coated in graphene. In embodiment 200, cathode 201 is present on cathode current collector 120. Cathode 201 is composed of cathode material particles that are coated in graphene. For example, coated cathode particle 210-1 may include a rounded or spherical piece of cathode material particle 212. Cathode material particles may have an average diameter be between 1-20 μm. Preferably, cathode material particles may have an average diameter between 3-6 μm. This cathode material may be NCA. Cathode material particles 212 may be coated in a layer of graphene particles 214. Graphene particles may have an average diameter between 0.1 and 3 μm. (Therefore, when coated in graphene, the coated particles may typically have a maximum diameter of 26 μm.) Preferably, graphene particles may have an average diameter between 0.3-0.6 μm. Each of coated cathode particles 210 may be structurally similar, but may vary in diameter.

Using cathode particles coated with graphene can allow for the cathode to have a higher density of cathode particles than if cathode particles are coated in, for example, solid electrolyte. That is, by using cathode particles coated in graphene, a reduction in the total content of solid electrolyte can be achieved. Such an arrangement can allow for the battery to have a higher energy density and/or can allow for the battery to have a same energy capacity but be smaller in size.

FIG. 3 illustrates an embodiment 300 of a cathode made from active material particles coated in graphene with solid electrolyte being interspersed with the active material particles coated in graphene. Embodiment 200 may include coated cathode particles 210 as detailed in relation to FIG. 2. Embodiment 300 includes solid electrolyte 310. Solid electrolyte 310 may be filled into the spaces between coated cathode particles. A solution may be made of electrolyte material and a liquid, poured onto coated cathode particles 210, and allowed to dry. As an example, the solid electrolyte may be Li₂S—P₂S₅ (e.g., 70%/30%). The solid electrolyte may be dissolved into a N-Methyl formamide solution. The liquid may then be removed, leaving the solid electrolyte within the gaps between coated cathode particles. Introduction of such a solid electrolyte into the empty space between coated cathode particles can increase the electroconductivity but can reduce the energy density (by introducing additional weight to the battery).

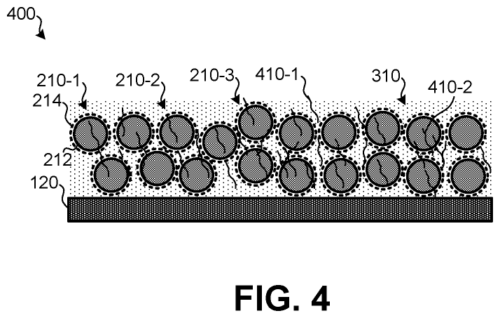

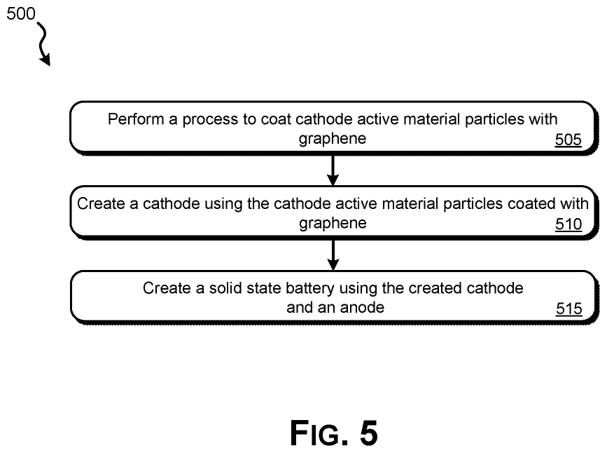

FIG. 4 illustrates an embodiment 400 of a cathode made from active material particles coated in graphene with solid electrolyte being interspersed with the active material particles coated in graphene. Embodiment 400 may include coated cathode particles 210 as detailed in relation to FIG. 2 and solid electrolyte 310 as detailed in relation to embodiment 300. Additionally, carbon fibers 410 may be added among the coated cathode particles. Carbon fibers 410, which can be referred to as vapor grown carbon fibers (VGCFs) can be cylindrical nanostructures that have graphene layers arranged as stacked cones, cups, or plates. VGCFs typically have sub-micrometer diameters with lengths between 3-100 μm. Carbon fibers 410 may increase the electroconductivity of the cathode. Introduction of carbon fiber strands (along with solid electrolyte) into the empty space between coated cathode particles can increase the electroconductivity but can reduce the energy density (by introducing additional weight to the battery).

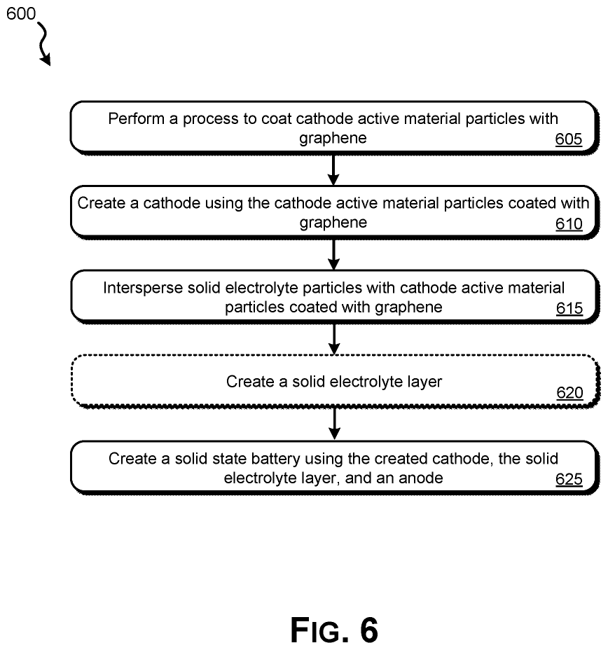

Various methods may be performed to create solid-state batteries that have a cathode made from graphene coated cathode particles. FIG. 5 illustrates an embodiment of a method 500 for creating a solid state battery. At block 505, cathode material particles may be coated with graphene by performing a process. Various different processes may be used. A first process may be mechano-nano-fusion, such as using a Nobilta Vercom NOB-VC dry particle composing machine. In mechano-nano-fusion, a rotor may be rotated around the inner surface of a vessel. The rotor may exert compression and shear forces on particles located between the rotor and the inner surface of the vessel. These forces may cause cathode particles (the core particles) and graphene (the guest particles) to rotate and be forced against each other, resulting in the graphene particles coating the cathode material particles. A second process may be spray coating with a fluidized bed, such as a SFP Series fine particle coater granulator manufactured by Powrex. Such a device can spray a coating agent (in this case graphene) in a liquid solution, into a housing having a rotating rotor and impeller. The cathode material particles are coated by the device with the coating agent.

At block 510, the coated cathode particles from block 505 may be used to create a cathode layer by layering the coated cathode particles onto a cathode current collector, such as an aluminum or gold foil. The coated cathode particles may be pressed to the cathode current collector to increase the density of particles in the cathode. At block 515, the cathode and the cathode current collector may be used to create a battery, such as by adding additional layers to form a battery as indicated in FIG. 1A or 1B. That is, the battery created at block 515 may not have an electrolyte layer or may have a thin electrolyte layer (compared to the thickness of the electrolyte layer that would be used if the cathode particles were not coated in graphene).

FIG. 6 illustrates an embodiment of another method for creating a solid state battery. Method 600 may represent a more detailed embodiment of method 500. At block 605, a cathode material particles may be coated with graphene by performing a coating process. Block 605 may be performed as detailed in relation to block 505.

At block 610, the coated cathode particles from block 505 may be used to create a cathode layer by layering the coated cathode particles onto a cathode current collector, such as an aluminum or gold foil. In some embodiments, the coated cathode particles may be pressed separately from the cathode current collector. That is, the coated cathode particles may be pressed and a cathode current collector may be added later in the process, such as at block 625. In some embodiments, as part of block 610, carbon fibers are introduced among the coated cathode particles. These carbon fibers have high electrical conductivity and, thus, can increase the electroconductivity of the cathode as a whole. The carbon fibers, which can be referred to as vapor grown carbon fibers (VGCFs) are cylindrical nanostructures that have graphene layers arranged as stacked cones, cups, or plates. VGCFs typically have sub-micrometer diameters with lengths between 3-100 μm. At block 615, solid electrolyte particles may be filled into the open regions between the coated cathode particles of the cathode. Since the coated cathode particles are approximately spherical, when the particles are layered onto each other, spaces remain between the particles, as seen in FIG. 2. At block 615, a wet process may be used to fill solid electrolyte into the space gaps between the coated cathode particles. A Li₂S—P₂S₅ (e.g., 70%/30%) solution with N-Methyl formamide may be allowed to soak into the cathode and dry (thus removing the N-Methyl formamide). This process can leave solid electrolyte between the coated cathode particles. Other solid electrolyte solutions may be possible.

At block 620, in some embodiments, a solid electrolyte layer may be formed such that it is positioned between the cathode layer and the anode layer. The solid electrolyte layer may be made using Li₂S—P₂S₅ or some other electrolyte. The electrolyte layer may function as a separator layer between the anode and cathode. The electrolyte layer may be thinner than if cathode particles were not coated in graphene. For example, a thickness of 20 μm may be used for the electrolyte layer as opposed to a more conventional 50 μm.

At block 625, a solid state battery may be created by stacking the cathode that has been soaked with the solid electrolyte solution and dried with an anode. A vacuum-based lamination process may be performed. If not added already, current collectors for the cathode, anode, or both may be added.

The following results have been achieved following methods 500 or 600. In a first example, cathode material particles were coated with graphene using the spray coating with a fluidized bed. Solid electrolyte was introduced to the cathode according to block 615. The cathode had an active material ratio of 85%. The cathode was created to have a thickness of 100 μm, a solid electrolyte layer of 20 μm was present between the cathode and anode, and the anode had a thickness of 42 μm. The theoretical energy density was expected to be 400 W/kg and the measured energy density was 300 W/kg. The storage capacity retention (which is defined as the percentage of energy stored in the 100^{th} cycle compared to the 2^{nd} cycle using a charge and discharge of 0.5 mAh/cm²), was measured to be 80%. In a second example, cathode material particles were coated with graphene using the mechano-nano-fusion method. Solid electrolyte was introduced to the cathode according to block 615. The cathode had an active material ratio of 85%. The cathode was created to have a thickness of 100 μm, a solid electrolyte layer of 20 μm was present between the cathode and anode, and the anode had a thickness of 42 μm. The theoretical energy density was expected to be 400 and the measured energy density was 280. The storage capacity retention (which is defined as the percentage of energy stored in the 100^{th} cycle compared to the 2^{nd} cycle using a charge and discharge of 0.5 mAh/cm²), was measured to be 85%.

While FIGS. 2-6 focused on embodiments related to cathodes, FIGS. 7-11 are directed to embodiments related to anodes. FIG. 7 illustrates an embodiment 700 of an anode made from active material particles coated in graphene. Graphene can function as both a solid electrode and as a conductive agent to increase the electroconductivity of the anode. Embodiment 700 can include: anode current collector 710; anode 720; solid electrolyte layer 730; cathode 740; and cathode current collector 750. Embodiment 700 can represent an embodiment of solid state battery 150 of FIG. 1B. Alternatively, embodiment 700 may not include solid electrolyte layer 730 and thus represent an embodiment of solid state battery 100 of FIG. 1A.

Embodiment 700 can be used in addition or in alternate to the graphene-coated cathode particles of FIGS. 2-6. Anode current collector 710 may be metallic, such as copper foil. Cathode 740 may be as detailed in FIGS. 2-6 or may be some other form of cathode.

Anode 720 may include: anode material particles (such as anode material particle 724); and graphene (such as graphene 726). Graphene 726 may be coated onto individual anode particle 724. Some or all individual anode particles may be similarly coated with graphene. Anode particles may be silicon or silicon oxide. Coated anode particle 722 may include a rounded or spherical piece anode particle 724. Anode material particles may have an average diameter be between 0.1 μm and 10 μm in diameter in case of Silicon and 1 and 20 μm in case of silicon oxide. Preferably, anode material particles may have an average diameter of 2 μm in case of silicon and 5 μm in case of silicon oxide. Anode material particles may be coated in a layer of graphene particles. Graphene particles may have an average diameter between 0.1 and 3 μm. (Therefore, when coated in graphene, the coated particles may typically have a maximum diameter of 0.3 μm to 26 μm for silicon and 1.2 μm to 26 μm.) Each of the coated anode particles may be structurally similar, but may vary in diameter due to variances in graphene particles and anode particles.

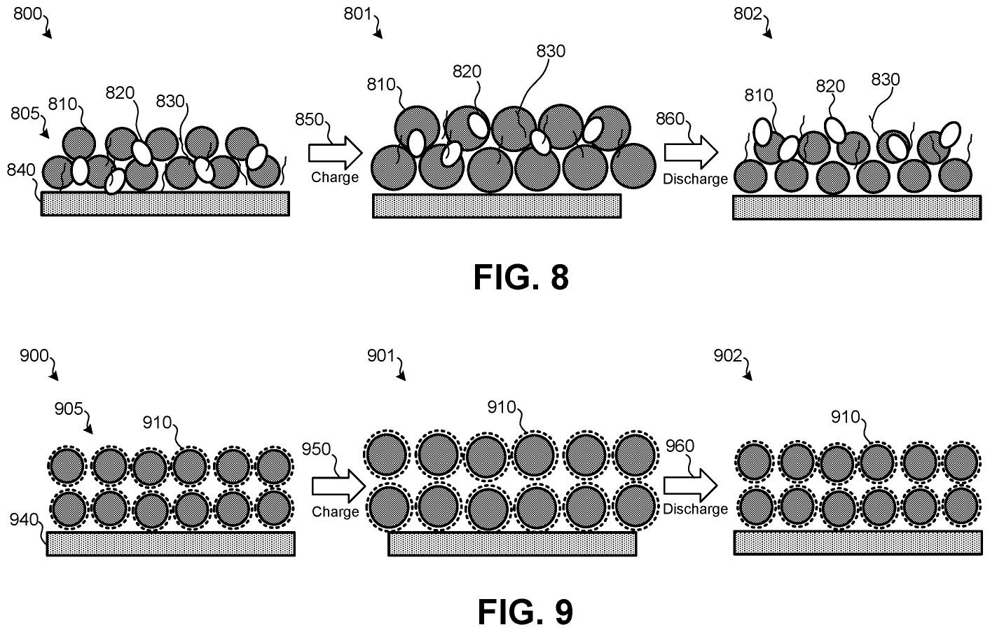

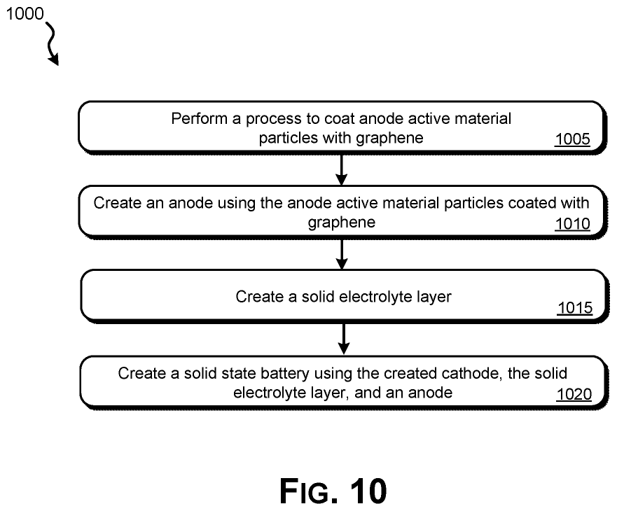

Graphene may exhibit good lithium ion conductivity, high electroconductivity, and have a high amount of flexibility. FIGS. 8 and 9 demonstrate advantages of using graphene coated anode particles. FIG. 8 illustrates an embodiment of an anode having bare silicon particles, conductive fibers, and conductive material that is exposed to charge and discharge cycles. In initial embodiment 800, bare anode particles (which can be silicon or silicon oxide), such as anode particle 810, are mixed with particles to improve electroconductivity. Such particles can include carbon fibers (vapor grown carbon fibers), such as carbon fiber 830 and solid electrolyte particles, such as solid electrolyte particle 820. Anode 805 may be made from such bare anode particles, carbon fibers, and/or solid electrolyte particles and attached to anode current collector 840.

When charged (indicated by transition 850), the anode particles, such as anode particle 810 may swell. This swelling may have undesirable consequences on other materials in anode 805. Such other materials, such as carbon fibers and solid electrolyte particles, may not swell or may not swell at the same rate as the anode particles. The swelling of the anode particles may displace the other materials, causing their positions to change. As seen in charged embodiment 801, the swelling of the anode particles has caused solid electrolyte particle 820 and carbon fiber 830 to move upward, away from anode current collector 840. The swelling in charged embodiment 801 can be quantified as a 300% swelling of silicon particles or a 200% swelling of silicon oxide particles.

Following a full or partial discharge (indicated by transition 860), as part of discharged embodiment 802, the swelling of anode particles may completely or partially subside. Such charge and discharge cycles may repeat many times. While the anode particles may return to the same or substantially the same size as in initial embodiment 800, the position of other materials may remain in shifted positions. The previous swelling may have caused solid electrolyte particle 820 and/or carbon fiber 830 to be displaced, such as away from anode current collector 840. Such displacement of conductive particles may adversely affect the energy density, power density, of anode 805, and thus the battery as a whole.

In contrast to the embodiment of FIG. 8, FIG. 9 illustrates an initial embodiment 900 of anode 905 that has graphene-coated silicon particles being exposed to charge and discharge cycles. In initial embodiment 900, anode active material particles that are coated in graphene, such as coated anode particle 910, are layered on anode current collector 940, which may be a copper foil. When charged, as indicated by transition 950, swelling of the anode active material within the coated anode particle (such as coated anode particle 910) may still occur; however the graphene coating may still coat the particles, even during swelling.

Following a full or partial discharge (indicated by transition 960), as part of discharged embodiment 902, the swelling of the coated anode particles may subside. Such charge and discharge cycles may repeat many times. The graphene coating of the anode particles may expand and contract with the underlying anode particles and remain undisplaced. Notably, since no additional materials are present as part of anode 905, such as particles to increase electroconductivity, there are no particles to be displaced by the reduced amount of swelling caused by charging. As such, the energy density, power density, or both of the battery cell of which anode 905 is a part may be less affected than the battery cell of which anode 805 is a part.

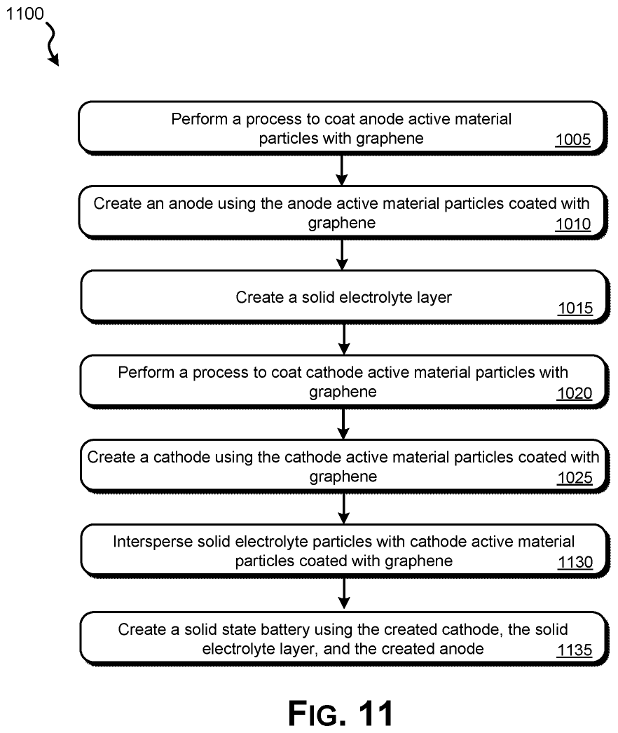

Various methods may be performed to create and used an anode that include graphene-coated anode active material particles. FIG. 10 illustrates an embodiment of a method 1000 for creating a solid state battery having coated anode particles. At block 1005, anode material particles may be coated with graphene by performing a process. Various different processes may be used. A first process may be mechano-nano-fusion, such as using a Nobilta® Vercom NOB-VC dry particle composing machine. In mechano-nano-fusion, a rotor may be rotated around the inner surface of a vessel. The rotor may exert compression and shear forces on silicon or silicon oxide particles located between the rotor and the inner surface of the vessel. These forces may cause the anode particles (referred to as the core particles) and graphene (referred to as the guest particles) to rotate and be forced against each other, resulting in the graphene particles coating the anode active material particles. A second process may be spray coating with a fluidized bed, such as a SFP Series fine particle coater granulator manufactured by Powrex®. Such a device can spray a coating agent (in this case graphene) in a liquid solution, into a housing having a rotating rotor and impeller. The anode active material particles are coated by the device with the coating agent.

At block 1010, the coated anode particles from block 1005 may be used to create an anode layer by layering the coated anode particles onto an anode current collector, such as copper foil. Machine milling and pressing may be applied to form the anode to the desired density and thickness. In some embodiments, the coated anode particles may be pressed separately from the anode current collector. That is, the coated anode particles may be pressed and an anode current collector may be added later in the process, such as at block 1020. In some embodiments, as part of block 1010, carbon fibers, solid electrolyte, or both are introduced among the coated anode particles. These carbon fibers have high electrical conductivity and, thus, can increase the electroconductivity of the anode as a whole.

At block 1015, in some embodiments, a solid electrolyte layer may be formed such that it is positioned between the cathode layer and the anode layer. The solid electrolyte layer may be made using Li₂S—P₂S₅ or some other solid electrolyte. The electrolyte layer may function as a separator layer between the anode and cathode. The electrolyte layer may be thinner than if anode particles were not coated in graphene. For example, a thickness of 20 μm may be used for the electrolyte layer as opposed to a more conventional 50 μm. In some embodiments, no solid electrolyte layer or separator layer may be needed.

At block 1020, a solid state battery may be created by stacking the created anode with the solid electrolyte and the cathode. A vacuum-based lamination process may be performed. If not added already, current collectors for the cathode, anode, or both may be added.

The following results have been achieved following method 1000. In a first example, silicon oxide was used to form the anode active material particles. The silicon oxide particles were coated with graphene. The composition was 90% active material and 10% graphene by weight. The cathode was made to be 100 μm in thickness, the solid electrolyte layer was made to be 20 μm in thickness, and the anode was made to be 11 μm in thickness. The theoretical energy density was expected to be 399 W/kg and the measured energy density was 350 W/kg. The storage capacity retention (which is defined as the percentage of energy stored in the 100^{th} cycle compared to the 2^{nd} cycle using a charge and discharge of 0.5 mAh/cm²), was measured to be 85%. In a second example, silicon was used to form the anode active material particles. The silicon particles were coated with graphene. The composition was 90% active material and 10% graphene by weight. The cathode was made to be 100 μm in thickness, the solid electrolyte layer was made to be 20 μm in thickness, and the anode was made to be 5 μm in thickness. The theoretical energy density was expected to be 405 W/kg and the measured energy density was 330 W/kg. The storage capacity retention (which is defined as the percentage of energy stored in the 100^{th} cycle compared to the 2^{nd} cycle using a charge and discharge of 0.5 mAh/cm²), was measured to be 80%.

Embodiments may be possible that use both the coated graphene cathode particles of FIGS. 2-6 and the coated anode particles of FIGS. 7-9 are possible. FIG. 11 illustrates an embodiment of a method 1100 for creating a solid state battery having coated cathode and coated anode particles. Method 1100 may be understood as a combination of some or all parts of methods 600 and 1000. At block 1105, anode material particles may be coated with graphene by performing a process. Various different processes, as detailed in relation to block 1005, may be used.

At block 1110, the coated anode particles from block 1105 may be used to create an anode layer by layering the coated anode particles onto an anode current collector, such as copper foil. In some embodiments, the coated anode particles may be pressed separately from the anode current collector. That is, the coated anode particles may be pressed and an anode current collector may be added later in the process, such as at block 1135. In some embodiments, as part of block 1110, carbon fibers, solid electrolyte, or both are introduced among the coated anode particles.

At block 1115, in some embodiments, a solid electrolyte layer may be formed such that it is positioned between the cathode layer and the anode layer. The solid electrolyte layer may be made using Li₂S—P₂S₅ or some other solid electrolyte. The electrolyte layer may function as a separator layer between the anode and cathode. The electrolyte layer may be thinner than if anode particles were not coated in graphene.

Block 1020 may be performed as detailed in relation to block 505. At block 1025, the coated cathode particles from block 1020 may be used to create a cathode layer by layering the coated cathode particles onto a cathode current collector, such as an aluminum or gold foil. In some embodiments, the coated cathode particles may be pressed separately from the cathode current collector. That is, the coated cathode particles may be pressed and a cathode current collector may be added later in the process, such as at block 1135. In some embodiments, as part of block 1025, carbon fibers (VGCFs) are introduced among the coated cathode particles.

At block 1130, solid electrolyte particles may be filled into the open regions between the coated cathode particles of the cathode. Since the coated cathode particles are approximately spherical, when the particles are layered onto each other, spaces remain between the particles, as seen in FIG. 2. At block 1030, a wet process may be used to fill solid electrolyte into the space gaps between the coated cathode particles. A Li₂S—P₂S₅ (e.g., 70%/30%) solution with N-Methyl formamide may be allowed to soak into the cathode and dry (thus removing the N-Methyl formamide). This process can leave solid electrolyte between the coated cathode particles. Other solid electrolyte solutions may be possible.

At block 1135, a solid state battery may be created by stacking the cathode that has been soaked with the solid electrolyte solution and dried with the anode of block 1010 and the solid electrolyte layer of block 1015. A vacuum-based lamination process may be performed. If not added already, current collectors for the cathode, anode, or both may be added.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner.

Specific details are given in the description to provide a thorough understanding of example configurations (including implementations). However, configurations may be practiced without these specific details. For example, well-known processes, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A solid state battery, comprising:
a cathode layer; and
an anode layer comprising active material anode particles, wherein individual active material anode particles are coated in graphene.

2. The solid state battery of claim 1, wherein the active material anode particles are silicon.

3. The solid state battery of claim 1, wherein the active material anode particles are silicon oxide.

4. The solid state battery of claim 1, further comprising a solid electrolyte layer located between the cathode layer and the anode layer.

5. The solid state battery of claim 4, wherein the solid electrolyte layer is between 10 μm and 30 μm in thickness.

6. The solid state battery of claim 1, wherein the anode layer is in direct contact with the cathode layer.

7. The solid state battery of claim 1, wherein the active material anode particles coated in graphene are less than 26 micrometers in diameter.

8. The solid state battery of claim 1, wherein the cathode layer comprises active material cathode particles that are individually coated in graphene.

9. The solid state battery of claim 8, wherein the active material cathode particles coated in graphene are less than 26 micrometers in diameter.

10. The solid state battery of claim 9, wherein an active material of the active material cathode particles is lithium nickel cobalt aluminum oxide.

11. A method for creating a solid state battery, the method comprising:
performing a process to coat active material anode particles with graphene;
creating an anode layer using the active material anode particles coated with graphene; and
creating the solid state battery using the created anode layer and a cathode layer.

12. The method for creating the solid state battery of claim 11, wherein the active material anode particles are silicon or silicon oxide.

13. The method for creating the solid state battery of claim 11, further comprising:
creating a solid electrolyte layer, wherein:
creating the solid state battery using the created anode layer and the cathode layer further comprises placing the solid electrolyte layer between the anode layer and the cathode layer.

14. The method for creating the solid state battery of claim 11, wherein performing the process to coat the active material anode particles with graphene comprises:
performing a mechanical nano-fusion process to coat the active material anode particles with graphene.

15. The method for creating the solid state battery of claim 11, wherein performing the process to coat the active material anode particles with graphene comprises:
performing a spray coating process to coat the active material anode particles with graphene.

16. The method for creating the solid state battery of claim 11, further comprising:
performing a second process to coat active material cathode particles with graphene, wherein individual cathode active material particles are coated with graphene; and
creating the cathode layer using active material cathode particles coated with graphene.

17. The method for creating the solid state battery of claim 16, wherein creating the cathode layer using the active material cathode particles coated in graphene further comprises adding solid electrolyte particles to the cathode layer.

18. The method for creating the solid state battery of claim 17, wherein adding solid electrolyte particles to the cathode comprises:
soaking the cathode layer comprising the active material cathode particles coated in graphene with a solid electrolyte suspended in a liquid; and
drying the cathode layer to remove the liquid from the cathode layer.

19. The method for creating the solid state battery of claim 18, wherein creating the cathode layer using the active material cathode particles coated in graphene further comprises adding carbon fiber strands to the cathode layer.

20. The method for creating the solid state battery of claim 11, wherein the active material anode particles coated in graphene are less than 26 micrometers in diameter.
